(19) United States
(12) Patent Application Publication
(10) Pub. No.: US 2022/0106033 A1
(43) Pub. Date: Apr. 7, 2022

(54) THRUST PRODUCING GYROSCOPE AUTOROTATION SAFETY SYSTEM METHOD AND APPARATUS

(71) Applicant: Airborne Motor Works Inc., Veradale, WA (US)

(72) Inventor: Jesse Antoine Marcel, Veradale, WA (US)

(21) Appl. No.: 17/496,620

(22) Filed: Oct. 7, 2021

Related U.S. Application Data
(60) Provisional application No. 63/088,775, filed on Oct. 7, 2020.

(51) Int. Cl. B64C 27/64; B64C 27/57; F02K 1/00

(52) U.S. Cl. CPC B64C 27/64; F02K 1/002; B64C 27/57

(57) ABSTRACT

The present invention comprises a novel autorotation safety device consisting of at least one compressed air tank that is configured to release high velocity air, either autonomously or through the actions of a pilot, into a thrust producing flywheel/rotor when the primary drive source for the rotors/fans have failed, creating a secondary drive system for safety. In preferred embodiments, when the primary drive system fails, and the air vehicle starts to descend, the invention will automatically inject high pressure air into the propulsion system's blades to create the thrust necessary to soften an emergency landing.

### PRIORITY CLAIM

This application claims the benefit of priority from U.S. Provisional Patent Application No. 63/088,775, filed Oct. 7, 2020, the contents of which is incorporated herein by reference.

### FIELD OF THE INVENTION

The invention relates to the field of air vehicles. More specifically, the invention comprises a safety device that injects high pressure air into the rotor blades of a ducted fan propulsion of air vehicles to affect rotation if the drive used to rotate the rotors fails.

### BACKGROUND OF THE INVENTION

Air vehicle safety systems include the ability to auto rotate their rotor blades when the primary power system fails. For example, as a helicopter falls to earth, the pilot levels the rotor blades causing them to spin up or increase revolutions per minute and when the helicopter is close to impacting the ground the pilot pulls up on the cyclic adding incidence to the rotor blades and the built in energy from the rotor is turned into thrust to allow for a softer landing.

### SUMMARY OF THE INVENTION

The present invention comprises a novel induced rotor rotation safety system generally consisting of at least one high pressure air tank that can be filled or repressurized when the vehicle using the device is refueled, which sends high pressure air into the flywheel/rotor blades creating a secondary emergency auto-rotation system. A pneumatic regulator valve releases high pressure air from the air tank into the flywheel/rotors causing rotation either manually by the pilot or autonomously through a system of avionics that detects a malfunction in the propulsion system that induces a free-fall. Nozzles located below the flywheel/rotor will induce spin when high-pressure air is aimed through their blades. In preferred embodiments, the nozzles are located in a cross member that supports the rotating rotor assembly and in close proximity to the flywheel/rotor's blades/fans.

### BRIEF DESCRIPTION OF THE DRAWINGS

Preferred and alternative examples of the present invention are described in detail below with reference to the following drawings.

FIG. 1 is an illustration of the system of this invention showing a prospective view.

FIG. 2 is an illustration of the system of this invention showing a cross section side view of a possible assembly.

FIG. 3 is an illustration of the system of this invention showing a simplified diagram of the various assemblies.

### DETAILED DESCRIPTION OF THE PREFERRED EMBODIMENT

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising” when used in this specification, specify the presence of stated features, steps operations, elements, and/or components, but do not preclude the presence of addition of one or more other features, steps, operations, elements, components, and/or groups thereof.

Unless otherwise defined, all terms (including technical and scientific terms) used herein have the same meaning as commonly understood by one having ordinary skill in the art to which the invention belongs. It will be further understood that terms, such as those defined in commonly used dictionaries, should be interpreted as having a meaning that is consistent with their meaning in the one context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combination are entirely within the scope of the invention and the claims.

New thrust producing gyroscope autorotation safety devices, apparatuses, and methods for creating a secondary means to accelerate a rotor/flywheel when the primary means of power fails are discussed herein. In the following description, for the purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

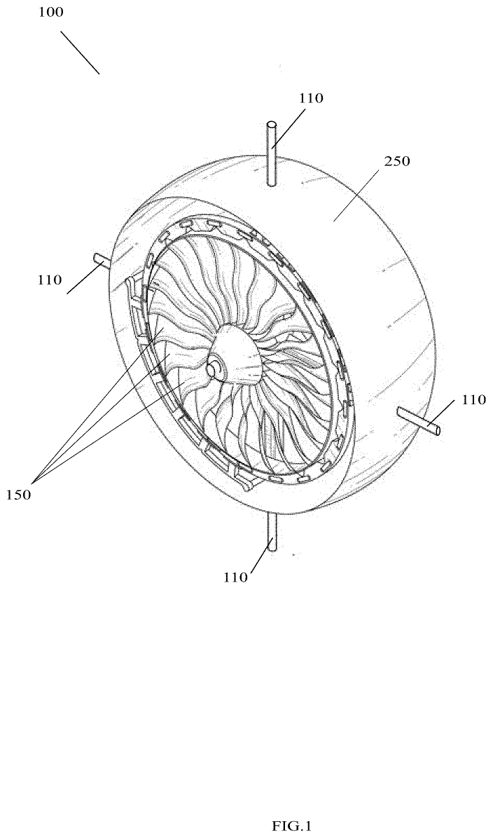

The present invention will now be described by referencing the appended figures representing preferred embodiments. Referring to FIG. 1, thrust producing gyroscope with autorotation assembly 100 is shown. The gyroscope assembly preferably includes a plurality of pneumatic lines 110 that inject gaseous fluids, which may be air, or another suitable gas, through a nacelle 250, which surrounds the flywheel rotor to induce spin, into flywheel/rotor blades 150.

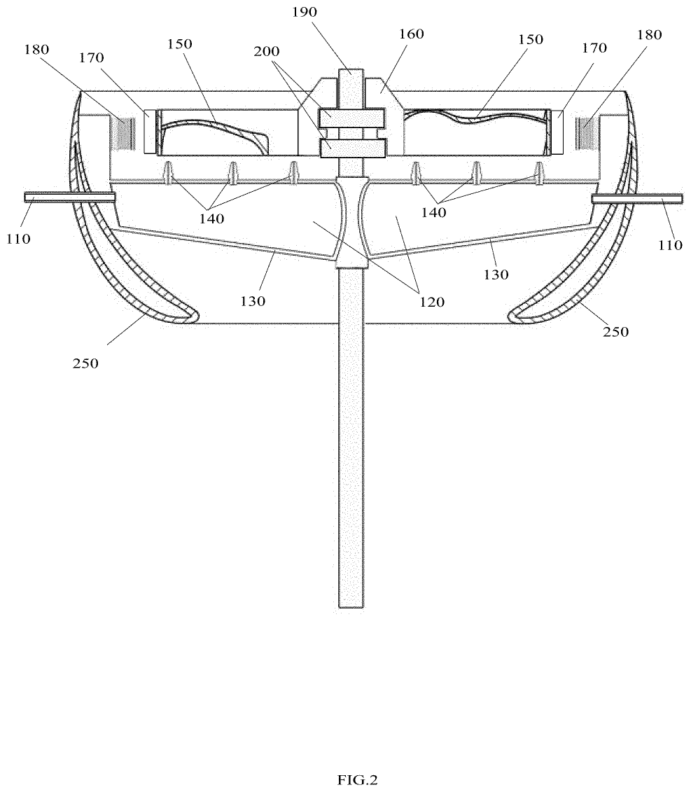

FIG. 2 depicts a cross-sectional view of the preferred embodiment of the gyroscope assembly 100. In this depiction, the pneumatic lines 110 direct high pressure air into a void 120 within crossmembers 130, which may be made of a composite, aluminum, or another suitable material. A plurality of nozzles 140 located in crossmembers 130 direct the high-pressure air from the void 120 into a plurality of the flywheel/rotor blades 150, causing rotation thereby creating thrust. In an alternate embodiment, nozzles 140 can be located instead of or in addition within the nacelle 250. The gyroscope assembly 100 may further include a hub 160, an outer ring 170 with a plurality of integrated permanent magnets that interacts with a stator of field coils 180 to create phasing magnetic fields when energized by a controller (not shown) to cause rotation of the flywheel/rotor blades 150, and bearings 200 that allows the rotor to freely rotate about a spindle 190. If the source causing this rotation fails, then the invention will cause the rotor to spin creating thrust and a softer landing.

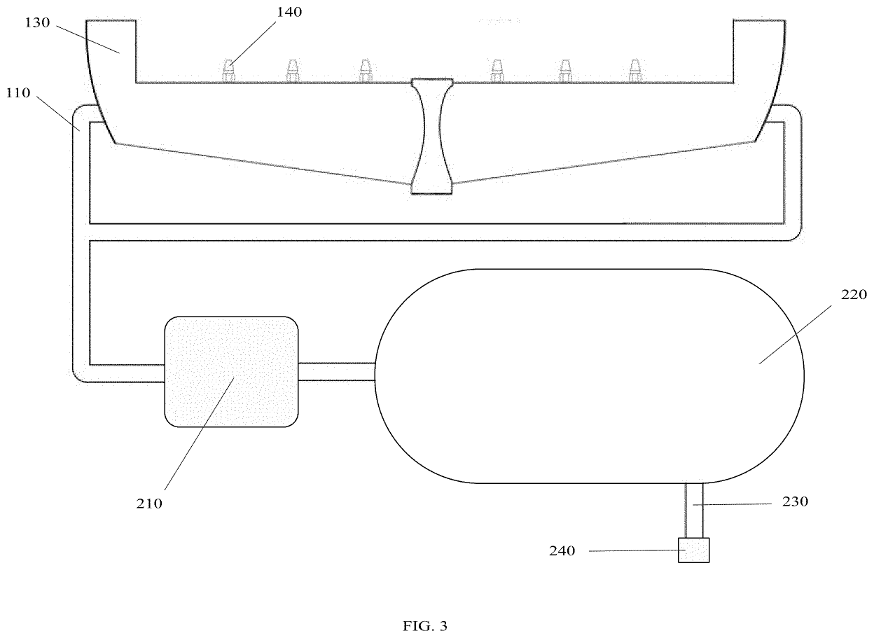

With further reference to FIG. 3, an air tank 220 is remotely filled via coupling 240 and pneumatic line 230 connected to a high-pressure air source, such as a compressor. A pneumatic regulator 210 serves as a valve that will open if an emergency occurs that dictates the need for auto ration of the flywheel/rotor, either autonomously or pilot directed, into the thrust producing flywheel/rotor blades 150 when an emergency occurs. The timing of the intervention of the safety system is crucial due to its limited operational time, and is preferably activated at the last possible moment necessary to still be effective while avoiding interference with normal operations of the air vehicle.

In one example, when the vehicle is having its batteries recharged, or petroleum fueled in the case of a combustion type jet engine, pneumatic tubing connected to a compressor will plug into the vehicle as part of the energy/fuel port to keep the air tank full. The valve can be controlled in a plurality of methods such as autonomously through avionics, or by the pilot. The pressure in the pneumatic tank can be monitored by viewing console gauges or avionics driven instrumentation. In a preferred embodiment, an emergency signal will occur if the pressure in the tank drops.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A safety system that supplies energy to rotate thrust-producing members of a ducted fan in a propulsion system, comprising:
a high-pressure gas cylinder configured to hold sufficient compressed gas to cause rotation of thrust producing members of the propulsion system;
at least one nozzle that direct the high-pressure gas into the thrust-producing members; and
a valve that controls distribution of the compressed gas into the at least one nozzle.

2. The safety system of claim 1, wherein the valve operation is controlled through avionics.

3. The safety system of claim 2, wherein the valve operation is automatically initiated when a free-fall event is detected.

4. The safety system of claim 1, wherein the valve operation is manually controlled.

5. The safety system of claim 1, wherein the status of the high-pressure gas cylinder is monitored by avionics driven instrumentation.

6. The safety system of claim 1, wherein the status of the high-pressure gas cylinder is manually monitored.

7. The safety system of claim 1, wherein an emergency signal will occur if there is a change in pressure in the high-pressure gas cylinder.

8. The safety system of claim 1, wherein a compressor is used to fill the high-pressure gas cylinder.
